(19) United States
(12) Patent Application Publication
(10) Pub. No.: US 2022/0193884 A1
(43) Pub. Date: Jun. 23, 2022

(54) TOOL ORGANIZER

(71) Applicant: Alan Paul Byrne, Mississauga (CA)

(72) Inventor: Alan Paul Byrne, Mississauga (CA)

(21) Appl. No.: 17/130,795

(22) Filed: Dec. 22, 2020

(51) Int. Cl. B25H 3/00

(52) U.S. Cl. CPC B25H 3/00

(57) ABSTRACT

A tool organizer configured to operably couple to the railings of an elevated work platform so as to provide access to tools, fasteners and other objects while being on the platform. The present invention includes a body that is planar in manner being manufactured from a material such as but not limited to polyester sheet. The body has a first side and a second side wherein present on the first side thereof are a plurality of storage and retention members. The storage and retention members are configured to releasably secure and/or retain objects. The body is movable between a stored position and a deployed position. In the deployed position the body is coupled to the top railing of the elevated work platform utilizing a rail support member. The body extends downward from the top railing and includes a lower securing strap to secure the body to a lower rail.

### FIELD OF THE INVENTION

The present invention relates generally to tool storage and organization, more specifically but not by way of limitation, an apparatus configured to provide tool storage, organization and accessibility for an individual utilizing an elevated work platform wherein the present invention provides availability to tools secured thereto or therein and is further configured to be foldable when not in use.

### BACKGROUND

Tool organizers and storage are well known in the art. There are numerous types of tool storage available that provide both storage and organization of tools. These devices can include but are not limited to portable tool boxes and workbenches having various tool compartments as a part thereof. While the aforementioned execute their desired tasks they lack application specific functionality. Individuals that need to utilize certain tools for specific tasks often find that conventional tool boxes and storage do not provide the necessary organization and accessibility when the individual is in certain places where work is required to be performed.

One tool that is utilized by many construction workers in known as an elevated work platform. The conventional elevated work platform includes a mobile base having a telescoping arm operably coupled thereto. The telescoping arm has a bucket on the end thereof wherein the bucket is configured to hold at least one worker therein. The buckets of the elevated work platforms include a floor and safety railings so as to prevent a working from falling off the elevated work platform when suspended above the ground. Many users of these elevated work platforms require specialized tools to perform their intended tasks. Construction workers often need devices such as but not limited to nail guns, screwdrivers and other hand tools in order to complete their work. Most workers will carry their required tools and place these tools on the floor of the elevated work platform bucket. The bucket has no storage and it is often inconvenient to carry a portable tool box as that can only be placed on the floor of the bucket and as such no advantage exists. One issue with placing tools on the floor of the elevated work platforms is the risk of the tool falling from the bucket and injuring someone below. Another disadvantage to tools being placed on the floor of the bucket of an elevated work platform is that they can be inconvenient to access when performing certain types of work.

It is intended within the scope of the present invention to provide a tool organizer that is configured to be secured to a bucket of an elevated work platform that provides organization and availability of tools for a user while present on the bucket of an elevated work platform.

### SUMMARY OF THE INVENTION

It is the object of the present invention to provide a tool organizer that is configured to provide organization and access to tools stored therein wherein the tool organizer is operably coupled to a bucket of an elevated work platform wherein the present invention is configured to be secured to the rails of the bucket.

Another object of the present invention is to provide a tool organizer that is configured to securely provide tools to a user disposed on a bucket of a work platform wherein the tool organizer includes a body that is planar in manner and manufactured from a collapsible material.

A further object of the present invention is to provide a tool organizer that is configured to provide organization and access to tools stored therein wherein the tool organizer is operably coupled to a bucket of an elevated work platform wherein the body includes a first side and a second side.

Still another object of the present invention is to provide a tool organizer that is configured to securely provide tools to a user disposed on a bucket of a work platform wherein the first side of the body has secured thereto a plurality of compartments.

An additional object of the present invention is to provide a tool organizer that is configured to provide organization and access to tools stored therein wherein the tool organizer is operably coupled to a bucket of an elevated work platform wherein the upper end of the body includes a rail support member that is configured to operably couple to the top rail of the bucket.

Yet a further object of the present invention is to provide a tool organizer that is configured to securely provide tools to a user disposed on a bucket of a work platform wherein the body includes a handle and a shoulder strap secured thereto.

Another object of the present invention is to provide a tool organizer that is configured to provide organization and access to tools stored therein wherein the tool organizer is operably coupled to a bucket of an elevated work platform wherein the body is manufactured from polyester sheet material.

An alternate object of the present invention is to provide a tool organizer that is configured to securely provide tools to a user disposed on a bucket of a work platform wherein the body further includes two securing straps proximate the midpoint thereof that are configured to operably couple with the middle rails of the bucket.

An alternative objective of the present invention is to provide a tool organizer that is configured to provide organization and access to tools stored therein wherein the tool organizer is operably coupled to a bucket of an elevated work platform that further incorporates a fastener such as but not limited to a zipper to secure the tool organizer in its stored position.

Another object of the present invention is to provide a tool organizer that is configured to securely provide tools to a user disposed on a bucket of a work platform wherein the first side of the body further includes securing loops configured to releasably retain a tool.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention in its fully deployed position; and

FIG. 2 is a side view of the present invention in its collapsed position;

FIG. 3 is a side view of the present invention in its deployed position; and

FIG. 4 is a perspective view of the present invention in its deployed position.

### DETAILED DESCRIPTION

References now to the drawings submitted herewith, wherein various elements depicted therein are not necessarily drawn to scale and wherein through the views and figures like elements are referenced with identical reference numerals, there is illustrated a tool organizer 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Drawings submitted as a part hereof, the tool organizer 100 includes a body 10 that is manufactured from a collapsible material such as but not limited to heavy duty polyester sheet. The body 10 includes an upper end 11 and lower end 12. The body further includes a first lateral edge 13 and second lateral edge 14. The preferred shape of the body 10 is rectangular but it is contemplated within the scope of the present invention that the body 10 could be formed in a plurality of alternate shapes and achieved the desired objective discussed herein. The body 10 includes a first side 16 and second side 17 wherein the first side 16 has a plurality of storage and retention members 20 that is further discussed herein.

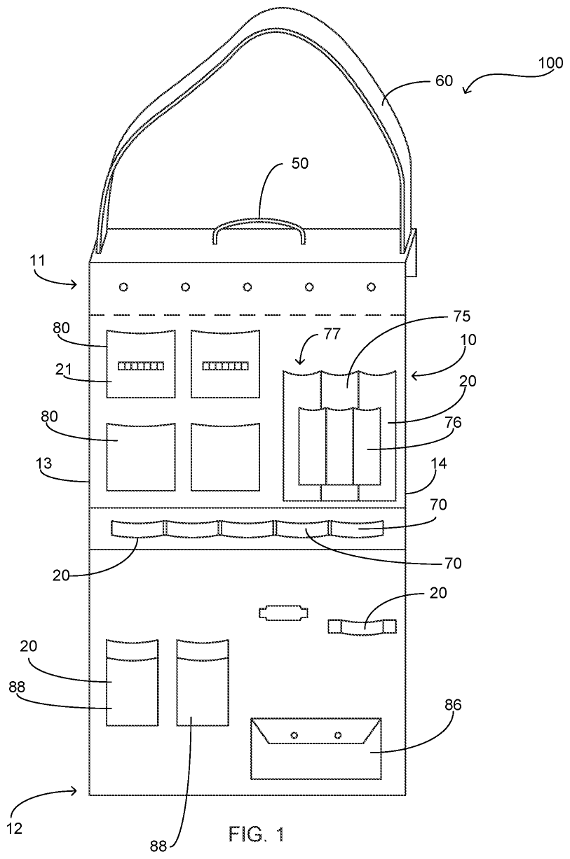

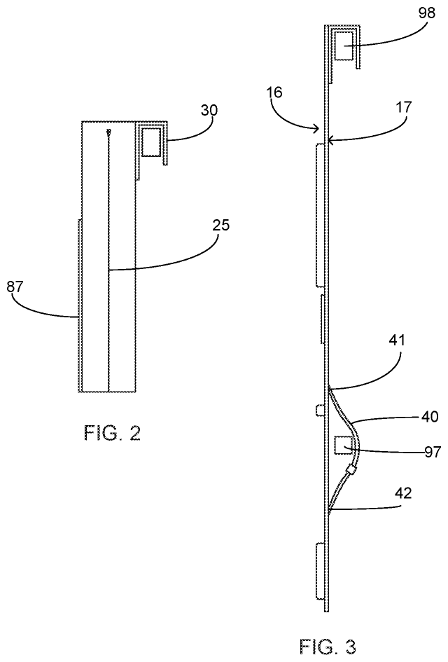

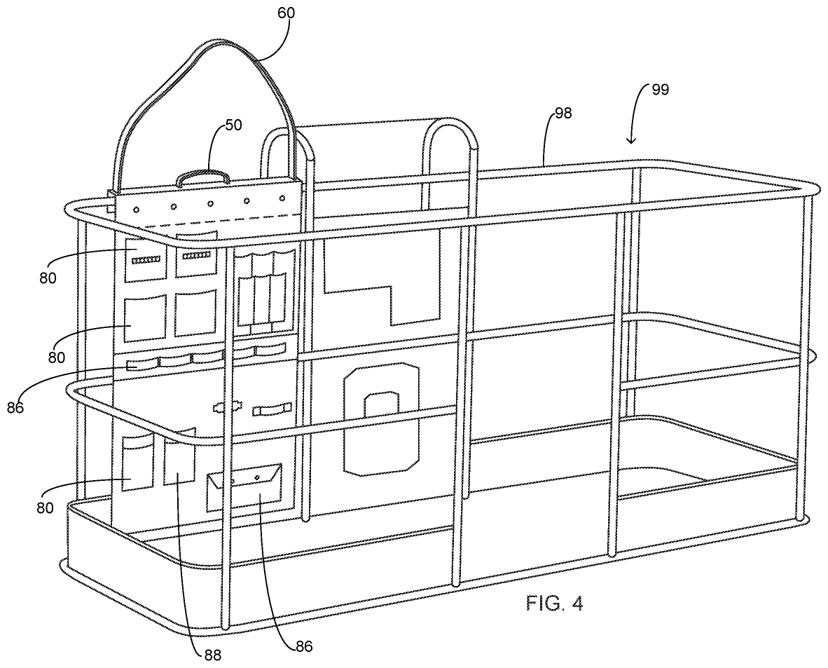

The body 10 is configured to be moved intermediate a stored position, illustrated herein in FIG. 2 and a deployed position, illustrated herein in FIGS. 1, 3 and 4. The body 10 includes fasteners 25 that are operable to retain the body 10 in its stored position and further facilitate movement to the deployed position. While no particular fastener is required, good results have been achieved utilizing zippers along the first lateral edge 13 and second lateral edge 14. Those skilled in the art should understand that the body 10 could deploy multiple quantities and types of fasteners 25 in order to achieve the desired function of transitioning the body 10 between a stored position and a deployed position. The body 10 includes a rail support member 30 integrally secured to the upper end 11 thereof. The rail support member 30 is manufactured from a suitable durable material such as but not limited to metal. The rail support member 30 extends between the first lateral edge 13 and second lateral edge 14 and is secured to the body 10 utilizing suitable durable chemical or mechanical techniques. The rail support member 30 is configured to be superposed the top rail 98 of the exemplary work platform 99 as is illustrated herein in FIGS. 3 and 4. It should be understood within the scope of the present invention that the rail support member 30 could be manufactured in alternate sizes in order to mateably superposed railings of alternate sizes.

The body 10 has secured thereto lower securing strap 40. The lower securing strap 40 include a first end 41 and a second end 42 that are secured to the second side 17 of the body utilizing durable chemical or mechanical techniques. The lower securing strap 40 is releasably secured to the body 10 proximate the second end 42 so as to be positioned around exemplary railing member 97. The lower securing strap 40 is secured around exemplary railing member 97 when the body 10 is moved to its deployed position. It should be understood within the scope of the present invention that the tool organizer 100 could employ alternate quantities of lower securing straps 40 in order to achieve the desired objective herein. The tool organizer 100 further includes a first handle 50 and second handle 60 secured proximate the upper end 11 of the body 10. The first handle 50 and second handle 60 are manufactured from suitable durable materials such as but not limited to nylon strap and are configured to provide two carrying options for the tool organizer 100.

The body 10 has a plurality of storage and retention members 20 secured to the first side 16 thereof. The storage and retention members 20 are uniquely constructed to provide retention and/or storage of items such as but not limited to tools and fasteners. A plurality of loop members 70 are present approximate the midpoint of the body 10. The loop members 70 are configured to be manufactured from a stretchable material so as to receive and releasably secure tools such as but not limited to hammers and screwdrivers. It should be understood within the scope of the present invention that the body 10 could have various quantities of loop members 70 and that the loop members 70 could be located in various positions on the first side 16 of the body 10. The body 10 further includes a plurality of securing sleeves 75 having integrated pockets 76 formed on the outer surface thereof. The securing sleeves 75 are constructed to have an opening 77 at the top thereof and be closed at the bottom. The securing sleeves 75 are elongated in shape and configured to receive a portion of various types of hand tools.

The body 10 further includes a plurality of retention pockets 80 secured proximate the upper end 11 and first lateral edge 13. The retention pockets 80 are manufactured from a suitable durable material such as but not limited to polyester sheet and are secured to the body 10 utilizing suitable techniques. The retention pockets 80 are operable to releasably secured therein alternate types of hand tools and/or fasteners. While four retention pockets 80 are illustrated herein, it should be understood within the scope of the present invention that the tool organizer could deploy alternate quantities of retention pockets 80. The body 10 further includes lower pocket members 88. The lower pocket members 88 are proximate the lower end 12 of the body 10 and are configured to receive and secure therein a plurality of tools and/or fasteners. It should be understood within the scope of the present invention that the body 10 could have secured thereto alternate quantities of the lower pocket members 88. Furthermore, it should be understood within the scope of the present invention that the lower pocket members 88 could be provided in alternate sizes and shapes.

Proximate the lower pocket members 88 is bottom pocket 86. Bottom pocket 86 is manufactured from the same material as the body 10 and includes a covered opening at the top portion thereof. While bottom pocket 86 is illustrated herein being rectangular in shape, it should be understood within the scope of the present invention that the bottom pocket 86 could be provided in alternate shapes and sizes. Exterior pocket 87 is provided on the body 10 as illustrated herein in FIG. 2. The exterior pocket 87 is provided to receive and store items such as but not limited to building plans. In a preferred embodiment the exterior pocket 87 extends the width of the body 10. The exterior pocket 87 is secured to the body 10 such that the exterior pocket 87 is accessible when the body 10 is in the stored position. While one exterior pocket 87 is discussed and illustrated herein it should be understood within the scope of the present invention that the tool organizer 100 could have more than one exterior pocket 87.

While the tool organizer 100 has been discussed herein as having a preferred application for use on an elevated work platform, it should be understood within the scope of the present invention that the tool organizer 100 could be utilized in alternate locations.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A tool organizer configured to be suspendedly mounted to a suitable support structure wherein the tool organizer comprises:
a body, said body being planar in manner, said body having a first side and a second side, said body having an upper end and a lower end, said body being manufactured from a durable sheet material, said body being movable between a stored position and a deployed position;
a support member, said support member being secured to said upper end of said body, said support member being configured to operably couple a suitable support structure in order to facilitate suspendedly mounting said body thereto;
at least one storage member, said at least one storage member being secured to said first side of said body, said at least one storage member configured to receive and retain an object therein; and
at least one retention member, said at least one retention member configured to releasably secure an object adjacent to said first side of said body.

2. The tool organizer as recited in claim 1, wherein in said stored position said first side of said body is inaccessible.

3. The tool organizer as recited in claim 2, and further including an exterior pocket said exterior pocket being secured to said body, said exterior pocket being accessible when said body is in said stored position.

4. The tool organizer as recited in claim 3, and further including a first handle and a second handle, said first handle and said second handle being proximate said upper end of said body secured proximate said support member.

5. The tool organizer as recited in claim 4, wherein said body further includes a plurality of securing loops, said plurality of securing loops being proximate a midpoint of said body, said plurality of securing lops being axially aligned horizontally across said body.

6. The tool organizer as recited in claim 5, wherein in said deployed position said body is adjacent the support structure and parallel therewith.

7. The tool organizer as recited in claim 6, wherein said body is manufactured from polyester sheet material.

8. A tool organizer configured to be suspendedly mounted to a railing of an elevated work platform wherein the tool organizer comprises:
a body, said body being planar in manner, said body having a first side and a second side, said body having an upper end and a lower end, said body having a first lateral edge, said body having a second lateral edge, said body being movable between a stored position and a deployed position;
a rail support member, said rail support member being proximate said upper end of said body, said rail support member configured to operably couple to a top rail of the elevated work platform, said rail support platform extending across said body intermediate said first lateral edge and said second lateral edge;
a plurality of loop members, said plurality of loop members being secured to said first side of said body, said plurality of loop members being proximate a midpoint of said body, said plurality of loop members extending horizontally across said first side of said body, said plurality of loop members configured to releasably secure an elongated object;
at least one storage member, said at least one storage member being secured to said first side of said body, said at least one storage member configured to receive an retain an object therein; and
wherein in said deployed position said body extends downward along railings of the elevated work platform.

9. The tool organizer configured to be suspendedly mounted a railing of an elevated work platform as recited in claim 8, and further including a fastener, said fastener being present along said first lateral edge and said second lateral edge, said fastener operable to facilitate maintaining said body in said stored position.

10. The tool organizer configured to be suspendedly mounted a railing of an elevated work platform as recited in claim 9, and further including at least one lower securing strap said at least one lower securing strap being proximate said lower end of said body, said at least one lower securing strap being configured to operably couple to an additional rail on the elevated work platform.

11. The tool organizer configured to be suspendedly mounted a railing of an elevated work platform as recited in claim 10, and further including an exterior pocket, said exterior pocket configured to be accessible when said body is in said stored position.

12. The tool organizer configured to be suspendedly mounted a railing of an elevated work platform as recited in claim 11, and further including a plurality of retention pockets, said plurality of retention pockets being proximate said first lateral edge and said upper end of said body, said plurality of retention pockets configured to receive and retain objects therein.

13. The tool organizer configured to be suspendedly mounted a railing of an elevated work platform as recited in claim 12, and further including a plurality of securing sleeves, said plurality of securing sleeves configured to releasably secure objects against said first side of said body.

14. The tool organizer configured to be suspendedly mounted a railing of an elevated work platform as recited in claim 13, and further including a first handle and a second handle, said first handle and said second handle being secured to said body proximate said upper end thereof, said second handle having a length that is greater than that of said first handle.

15. A tool organizer configured to be suspendedly mounted to a railing of an elevated work platform so as to position tools and objects towards the interior of the elevated work platform wherein the tool organizer comprises:
a body, said body being planar in manner, said body being manufactured from a polyester sheet material, said body having a first side and a second side, said body having an upper end and a lower end, said body having a first lateral edge, said body having a second lateral edge, said body being movable between a stored position and a deployed position;
a rail support member, said rail support member being proximate said upper end of said body, said rail support member configured to operably couple to a top rail of the elevated work platform, said rail support platform extending across said body intermediate said first lateral edge and said second lateral edge;
a lower securing strap, said lower securing strap being secured to said second side of said body, said lower securing strap being proximate said lower end of said body, said lower securing strap operably to secure said body to a lower rail of the elevated work platform;
a plurality of loop members, said plurality of loop members being secured to said first side of said body, said plurality of loop members being proximate a midpoint of said body, said plurality of loop members extending horizontally across said first side of said body, said plurality of loop members configured to releasably secure an elongated object;
a plurality of storage members, said plurality of storage members being secured to said first side of said body, said plurality of storage members configured to receive an retain an object therein; and
wherein in said deployed position said body extends downward along railings of the elevated work platform.

16. The tool organizer configured to be suspendedly mounted to a railing of an elevated work platform as recited in claim 15, and further including a plurality of securing sleeves, said plurality of securing sleeves secured to said first side of said body, said plurality of securing sleeves configured to releasably secure objects against said first side of said body.

17. The tool organizer configured to be suspendedly mounted to a railing of an elevated work platform as recited in claim 16, and further including a plurality of retention pockets, said plurality of retention pockets being secured to said first side of said body, said plurality of retention pockets being proximate said first lateral edge and said upper end of said body, said plurality of retention pockets configured to receive and retain objects therein.

18. The tool organizer configured to be suspendedly mounted to a railing of an elevated work platform as recited in claim 17, and further including an exterior pocket, said exterior pocket configured to be accessible when said body is in said stored position.

19. The tool organizer configured to be suspendedly mounted to a railing of an elevated work platform as recited in claim 18, and further including a fastener, said fastener being present along said first lateral edge and said second lateral edge, said fastener operable to facilitate maintaining said body in said stored position.

20. The tool organizer configured to be suspendedly mounted to a railing of an elevated work platform as recited in claim 19, and further including a bottom pocket, said bottom pocket having a flap covering an opening thereof, said bottom pocket being secured to said first side of said body proximate said lower end.
